(19) United States
(12) Patent Application Publication
(10) Pub. No.: US 2006/0127111 A1
(43) Pub. Date: Jun. 15, 2006

(54) Toner concentration sensor

(75) Inventor: Chihiro Komori, Yokohama (JP)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/298,503

(22) Filed: Dec. 12, 2005

(30) Foreign Application Priority Data
Dec. 14, 2004 (JP) 2004-361131
Aug. 30, 2005 (KR) 10-2005-0079988

(51) Int. Cl. G03G 15/08

(52) U.S. Cl. 399/30

(57) ABSTRACT

A toner concentration sensor used in an electrophotographic recording apparatus using a 2-component developing method, includes a storage storing a developer including a toner and a carrier, a first oscillator including a first resonance circuit including a coil and a condenser, the coil of the first resonance circuit being disposed in a place where an inductance of the coil varies with a permeability of the developer stored in the storage, a second oscillator including a second resonance circuit including a coil and a condenser, the coil of the second resonance circuit being disposed in a place where an inductance of the coil is constant, and a detector for detecting outputted oscillator frequencies of the first and second oscillators to determine the permeability of the developer. Accordingly, the concentration of the toner is detected from the permeability of the developer.

### CROSS-REFERENCE TO RELATED PATENT APPLICATION

This application claims the benefit under 35 U.S.C. § 119(a) of Japanese Patent Application No. 2004-361131, filed on Dec. 14, 2004, in the Japan Patent Office, and Korean Patent Application No. 10-2005-0079988, filed on Aug. 30, 2005, in the Korean Intellectual Property Office, the entire disclosures of which are hereby incorporated by reference.

### BACKGROUND OF THE INVENTION

1. Field of the Invention

The present invention relates to a toner concentration sensor. More particularly, the present invention relates to a toner concentration sensor used in an electrophotographic recording apparatus adopting a 2-component developing method using a mixture of a magnetic substance called a carrier and toner that is a colorant.

2. Description of the Related Art

An electrophotographic image recording apparatus, such as a printer, adopts a 2-component developing method using a mixture of a magnetic substance called a carrier and toner that is a colorant. Japanese Patent Publication No. 2002-296893 discloses a 2-component developing method that uses a permeability sensor for detecting mixture ratio of a carrier and toner to optimally maintain the mixture ratio.

FIG. 11 is a circuit diagram of a conventional toner concentration sensor circuit. As shown in FIG. 11, the conventional toner concentration sensor circuit includes an oscillator circuit including a differential transformer 101, condensers 102 and 103, a resistor 104, and an XOR gate 105; a buffer circuit including condensers 106 and 107 for shaping waveforms of an output from another coil of the differential transformer 101, a resistor 108, and an AND gate 109; and an integrator circuit including an XOR gate 110 for comparing phase differences of the waveforms, a resistor 111, and a condenser 112.

Typically in the conventional toner concentration sensor circuit, when a mixture of the toner and carrier exists near the differential transformer 101, inductances of coils of the differential transformer 101 are unbalanced with variations in permeability of the mixture. Accordingly, overlaps between rectangular waves formed by shaping the phase differences obtained by the differential transformer 101 are detected and integrated so as to obtain an analog voltage that is proportional to the phase differences.

When the concentration of toner of a developer is reduced, the concentration of the carrier that is a magnetic substance is relatively increased and the permeability is increased. However, if the concentration of the toner is increased, the concentration of the carrier is relatively reduced and the permeability is reduced. Thus, the concentration of the toner of the developer can be detected by observing the permeability.

Since the conventional toner concentration sensor circuit detects variations in the permeability using the phase differences obtained by the differential transformer 101, a detectable dynamic range is narrow. As a result, sensitivity of the permeability is high and exceeds the observation range. The phase detection circuit becomes saturated, resulting in an analog output of “0” or a maximum value. Therefore, positions of cores of the differential transformer 101 must be calibrated one by one as operation points, at which a variation in an output is maximum with a desired permeability. Also, the cores must be calibrated during manufacturing of the conventional toner concentration sensor circuit. Furthermore, the cost of concentration sensors is high. In addition, since the concentration sensors have a high impedance at an analog voltage, the concentration sensors are weak to noise. Also, a highly reliable connector is required to be used. All of thee factors drive up manufacturing cost, and the complexity of the manufacturing process.

Accordingly, there is a need for an improved toner concentration sensor which detects the permeability of the toner concentration with a wide detectable dynamic range.

### SUMMARY OF THE INVENTION

An aspect of the present invention is to address at least the above problems and/or disadvantages and to provide at least the advantages described below. Accordingly, an aspect of the present invention is to provide a toner concentration sensor that does not require calibration, reduces manufacturing cost, and has a wide dynamic range.

According to an aspect of the present invention, a toner concentration sensor used in an electrophotographic recording apparatus using a 2-component developing method includes a storage for storing a developer including a toner and a carrier. A first oscillator comprises a first resonance circuit including a coil and a condenser. The coil of the first resonance circuit is disposed in a place where an inductance of the coil varies with permeability of the developer stored in the storage. A second oscillator includes a second resonance circuit including a coil and a condenser. The coil of the second resonance circuit is disposed in a place where an inductance of the coil is constant, and a detector for detecting oscillator frequencies of the first and second oscillators to measure the permeability of the developer. Accordingly, the concentration of the toner may be detected from the permeability of the developer.

Oscillator outputs of the first and second oscillators may be transmitted through electron induction by a detection coil installed near the coils on a structure of a main body of the electrophotographic recording apparatus supporting the storage that stores the developer.

Additionally, the coil of the second oscillator is preferably disposed near a standard sample having a reference standard permeability.

In addition, the standard sample has a reference permeability, wherein the standard sample periodically performs an approach and a separation around the coil of the first oscillator during rotation of the standard sample, a depletion of a portion of the developer formed on a lower housing the comprises the developer, or an installation of an element around the coil of the first oscillator that performs the depletion of a portion of the developer.

Furthermore, the oscillator outputs of the first and second oscillators may be detected, and a ratio or difference between the oscillator frequencies of the first and second oscillators may be obtained so as to detect the permeability of the developer.

A logic circuit obtaining the ratio or the difference between the oscillator frequencies of the first and second oscillators preferably includes a counter for counting the oscillator outputs of the first and second oscillators.

Other objects, advantages, and salient features of the invention will become apparent to those skilled in the art from the following detailed description, which, taken in conjunction with the annexed drawings discloses exemplary embodiments of the invention.

### BRIEF DESCRIPTION OF THE DRAWINGS

The above and other objects, features and advantages of certain exemplary embodiments of the present invention will become more apparent from the following description taken in conjunction with the accompanying drawings in which:

FIG. 1 is a side view illustrating an arrangement of a toner concentration sensor according to an embodiment of the present invention;

FIG. 2 is a view illustrating concentration sensor units mounted on a printed circuit board (PCB) according to an embodiment of the present invention;

FIG. 3 is a circuit diagram illustrating configurations of toner concentration sensor units according to an embodiment of the present invention;

FIG. 4 is a circuit diagram illustrating structures extracting output signals from toner concentration sensor units in a non-contact way according to an embodiment of the present invention;

FIG. 5 is a block diagram of a logic operational circuit of a toner concentration sensor according to an embodiment of the present invention;

FIG. 6 is a timing chart illustrating the logic operational circuit of the toner concentration sensor shown in FIG. 5;

FIG. 7 is a block diagram of a logic operational circuit of a toner concentration sensor according to another embodiment of the present invention;

FIG. 8 is a timing chart illustrating the logic operational circuit of the toner concentration sensor shown in FIG. 7;

FIG. 9 is a side view illustrating an arrangement of a toner concentration sensor according to another embodiment of the present invention;

FIG. 10 is a side view illustrating an arrangement of a toner concentration sensor according to still another embodiment of the present invention; and

FIG. 11 is a circuit diagram illustrating a conventional toner concentration sensor.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

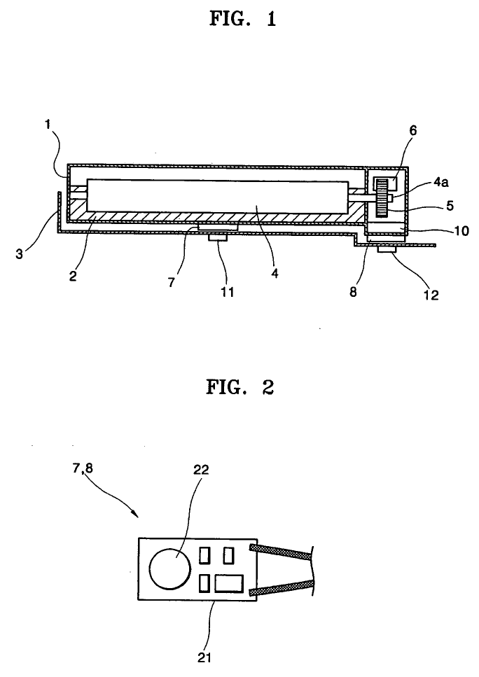

FIG. 1 is a side view illustrating an arrangement of a toner concentration sensor according to an exemplary embodiment of the present invention. Referring to FIG. 1, a housing 1 includes a developing unit structure and may store a developer 2 using a toner feeder (not shown) that feeds an amount of toner as much as necessary. The developer 2 is a mixture of a magnetic carrier and toner that is a colorant. The housing 1 is supported by a lower chassis 3.

A mixer 4 uniformly maintains a concentration of the developer 2 in the housing 1 and uniformly mixes the toner and carrier. A driving gear 5 is installed at a rotation shaft 4a of the mixer 4 and gears with a driving gear 6. The driving gear 6 is rotated by a motor (not shown), and this rotation force is transmitted through the driving gears 6 and 5 to the mixer 4. Thus, the mixer 4 rotates in the housing 1, and the developer 2 in the housing 1 is agitated in order to uniformly mix the toner and carrier.

A concentration sensor unit 7 is installed on a structure comprising a storage for storing the developer 2. A standard sample 10 having a reference permeability is placed on a portion of the structure that is not affected by the developer 2, such as, under the driving gears 5 and 6. A concentration sensor unit 8 is installed near the standard sample 10. The concentration sensor unit 7 preferably has substantially the same structure as the concentration sensor unit 8.

The concentration sensor units 7 and 8 include oscillators and are preferably installed on a PCB 21 as shown in FIG. 2. A coil 22 determining oscillator frequencies of the oscillator is mounted on the PCB 21.

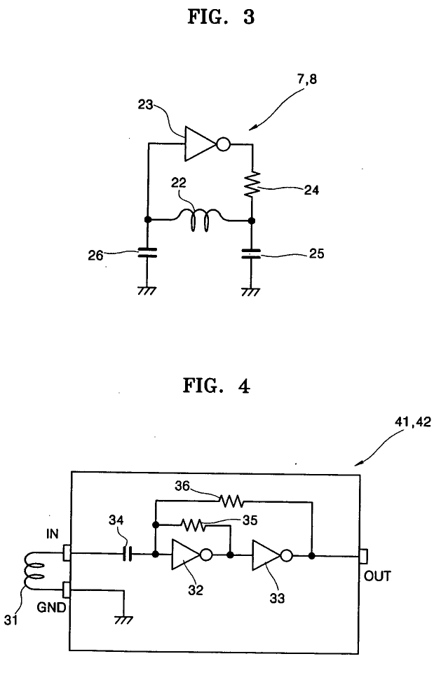

FIG. 3 is a circuit diagram of the concentration sensor units 7 and 8. The concentration sensor units 7 and 8 comprise an inverter 23 that includes a CMOS integrated circuit (IC) of a gate. A resistor 24 and a condenser 25 that are connected between an output node of the inverter 23 and a ground. A second condenser 26 is connected between an input node of the inverter 23 and a ground. The coil 22 is connected between the condensers 25 and 26.

The oscillator includes a resonance circuit including the condensers 25 and 26 and the coil 22, the resistor 24 determining a gain, and the inverter 23. The oscillator oscillates at an oscillator frequency having square waves, wherein the oscillator frequency is determined by capacitances of the condensers 25 and 26 and an inductance of the coil 22.

The coil 22 is mounted on the PCB 21 as shown in FIG. 2. The concentration sensor unit 7 is disposed on the structure comprising the storage storing the developer 2. Thus a periphery of the coil 22 of the concentration sensor unit 7 is filled with the developer 2. If the concentration of the toner is lowered, the concentration of the carrier as the magnetic substance is relatively increased and the permeability is increased. If the concentration of the toner is increased, the concentration of the carrier is relatively decreased and the permeability is reduced. Thus, the inductance of the coil 22 of the concentration sensor unit 7 varies according to variations in the permeability which is related to the concentration of the toner. The concentration sensor unit 7 outputs a signal of the oscillator frequency depending on the concentration of the toner.

The concentration sensor unit 8 is positioned near the standard sample 10, such as, in a place that is not affected by the developer 2. Thus, the oscillator frequency of the concentration sensor unit 8 becomes a reference frequency.

An oscillator output of the concentration sensor unit 7 is an oscillator output of a frequency depending on the concentration of the toner. However, an oscillator output of the concentration sensor unit 8 is constant from the oscillator output of the concentration sensor unit 7. The oscillator frequencies of the concentration sensor units 7 and 8 may be compared to detect the toner concentration of the developer 2.

Output signals of the concentration sensor units 7 and 8 may be extracted in a non-contact way by detection coils 11 and 12 as shown in FIG. 1.

FIG. 4 is a circuit diagram illustrating a structure for extracting the output signals of the concentration sensor units 7 and 8 using the detection coils 11 and 12 in the non-contact way. As shown in FIG. 4, a detection coil 31 corresponds to the detection coils 11 and 12 and is disposed near the coil 22 of the concentration sensor units 7 and 8 shown in FIG. 3.

The output signals of the concentration sensor units 7 and 8 are induced and received by the coil 22 and the detection coil 31. The detected output signals are amplified and outputted by a buffer amplifier and waveform shaping circuit that preferably includes NAND gates 32 and 33, and a preamplifier. The preamplifier includes a coupling condenser 34, and feedback resistors 35 and 36.

The detection coil 31 preferably has hundreds of turns and a value on the order of hundreds of μH, has a low impedance, and is little affected by a wire length from the detection coil 31 to an input of the preamplifier, such as by noise. Thus, a circuit subsequent to the preamplifier may be mounted on a PCB constituting a control circuit of an output apparatus (not shown).

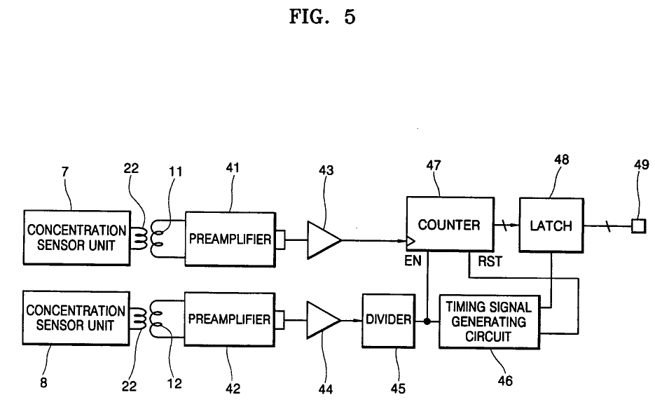

FIG. 5 is a circuit diagram of a logic operational circuit for detecting the permeability of the developer 2 by using the oscillator outputs of the concentration sensor units 7 and 8 to detect the concentration of the toner according to an embodiment of the present invention.

As shown in FIG. 5, the oscillator output of the concentration sensor unit 7 is supplied to a preamplifier 41 through the coil 31 shown in FIG. 4 in a non-contact way. The oscillator output of the concentration sensor unit 8 is supplied to a preamplifier 42 through the coil 31 shown in FIG. 4 in a non-contact way. The preamplifiers 41 and 42 preferably have structures as shown in FIG. 4.

An output signal of the preamplifier 41 is supplied to a counter 47 through a buffer amplifier 43.

An output signal of the preamplifier 42 is supplied to a divider 45 through a buffer amplifier 44 so as to be divided into 1/n. An output signal of the divider 45 is an enable signal, which is supplied to an enable node of the counter 47 and a timing signal generating circuit 46. A reset signal and a latch signal are generated by the timing signal generating circuit 46. A count value of the counter 47 is latched by a latch 48 and outputted from an output node 49.

In the logic operational circuit having the above-described structure, the oscillator output of the concentration sensor unit 8 is a reference frequency and divided into 1/n by the divider 45. An output of the divider 45 is used as an enable signal to count the oscillator output of the concentration sensor unit 7 using the counter 47. The oscillator frequency of the concentration sensor unit 7, based on the oscillator frequency of the concentration sensor unit 8, is detected using the counter value of the counter 47. The counter value of the counter 47 is latched by the latch 48, and data corresponding to the concentration of the toner is outputted from the output node 49.

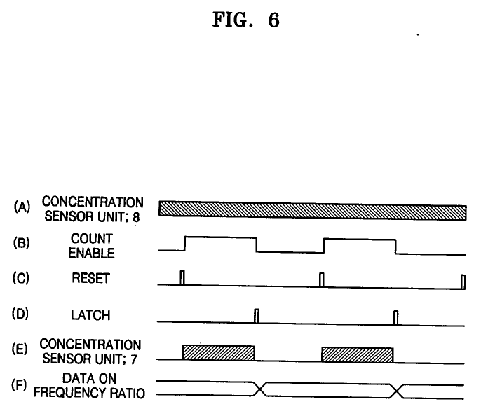

FIG. 6 is a timing chart illustrating the operation of the logic operational circuit shown in FIG. 5. The oscillator output of the concentration sensor unit 8 is input through the preamplifier 42 and a buffer amplifier 44 as shown in (A) of FIG. 6. The oscillator output of the concentration sensor unit 8 is divided into 1/n by the divider 45. The divider 45 outputs a signal shown in (B) of FIG. 6. The signal output from the divider 45 is a count enable signal supplied to the counter 47. A reset signal shown in (C) of FIG. 6 and a latch signal shown in (D) of FIG. 6 are generated from the signal output from the divider 45.

The oscillator output of the concentration sensor unit 7 is input through the preamplifier 41 and a buffer amplifier 43 as shown in (E) of FIG. 6. The counter 47 is reset by the reset signal shown in (C) of FIG. 6 and then counts the oscillator output of the concentration sensor unit 7 shown in (E) of FIG. 6 when the count enable signal shown in (B) of FIG. 6 is on a logic “high.” This upcount and/or down count value is latched by the latch 48 as shown in (F) of FIG. 6 according to the latch signal shown in (D) of FIG. 6.

As described above, the oscillator output of the concentration sensor unit 8 is divided to generate the count enable signal. The counter 47 counts the oscillator output of the concentration sensor unit 7 during the enable signal. In this case, if the oscillator frequency of the concentration sensor unit 7 is “fa” and the oscillator frequency of the concentration sensor unit 8 is “fb,” a count value “m” is “m=n*(1+fa/fb).” Thus, the count value of the counter 47 corresponds to a ratio between the oscillator frequency of the concentration sensor unit 8 and the oscillator frequency of the concentration sensor unit 7.

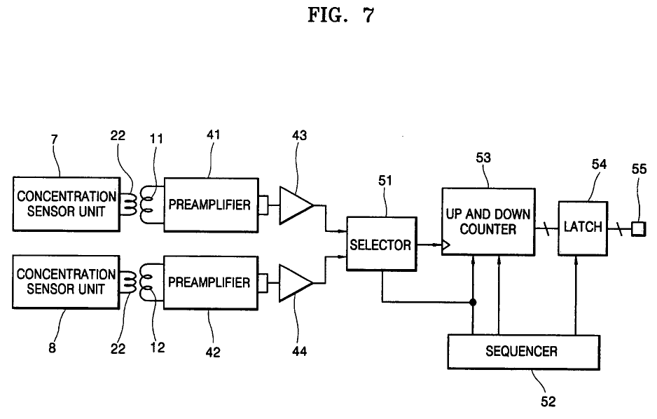

FIG. 7 is a block diagram of a logic operational circuit detecting the permeability of the developer 2 using the oscillator outputs of the concentration sensor units 7 and 8 to detect the concentration of the toner according to another embodiment of the present invention.

As shown in FIG. 7, the oscillator output of the concentration sensor unit 7 is supplied to a preamplifier 41 through the coil 31 shown in FIG. 4 in a non-contact way. The oscillator output of the concentration sensor unit 8 is supplied to a preamplifier 42 through the coil 31 shown in FIG. 4 in a non-contact way. The preamplifiers 41 and 42 have the structures as shown in FIG. 4.

An output signal of the preamplifier 41 is supplied through a buffer amplifier 43 to a selector 51. An output signal of the preamplifier 42 is supplied through a buffer amplifier 44 to the selector 51. The selector 51 is switched by a sequencer 52.

The oscillator output of the concentration sensor unit 7 through the preamplifier 41 and the buffer amplifier 43 and the oscillator output of the concentration sensor unit 8 through the preamplifier 42 and the buffer amplifier 44 are alternately output via the selector 51. An output signal of the selector 51 is supplied to an up and down counter 53.

The up and down counter 53 is reset by a reset signal output from the sequencer 52 and repeats upcounting and downcounting according to an enable signal output from the sequencer 52. A count value of the up and down counter 53 is latched by a latch 54 according to a latch signal output from the sequencer 52, and data corresponding to the concentration of the toner is output from an output node 55.

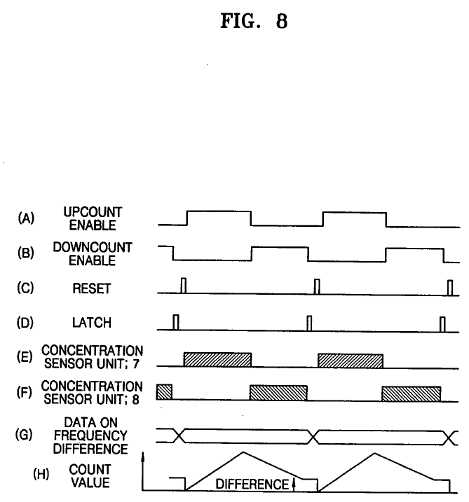

FIG. 8 is a timing chart illustrating the operation of the logic operational circuit shown in FIG. 7. The sequencer 52 outputs a reset signal at a timing shown in (C) of FIG. 8 and then an upcount enable signal at a timing shown in (A) of FIG. 8. When the upcount enable signal is on a logic level “high,” the up and down counter 53 upcounts the oscillator output of the concentration sensor unit 7. A downcount enable signal is output at a timing shown in (B) of FIG. 8. When the downcount enable signal is on a logic level “high,” the up and down counter 53 downcounts the oscillator output of the concentration sensor unit 8. Thus, the count value of the up and down counter 53 varies as shown in (H) of FIG. 8.

If the oscillator frequency of the concentration sensor unit 7 is “fa” and the oscillator frequency of the concentration sensor unit 8 is “fb,” the count value “m” of the up and down counter 53 is “m=fa−fb.” Thus, the count value of the up and down counter 53 corresponds to a difference between the oscillator frequencies of the concentration sensor units 7 and 8.

The count value of the up and down counter 53 is latched by the latch 54 according to a latch signal shown in (D) of FIG. 8, and the up and down counter 53 is reset by a reset signal shown in (C) of FIG. 8. Data of the latch 53 is extracted from the output node 55.

When the inductance of the coil 22 is 100 μH and the capacitances of the condensers 25 and 26 are each 200 pF, the oscillator frequencies of the concentration sensor units 7 and 8 shown in FIG. 4 are each about 1.6 MHz without the developer 2. When the developer 2 fills the periphery of the coil 22 of the concentration sensor unit 7, the oscillator frequencies of the concentration sensor units 7 and 8 are each about 1 MHz. A frequency deviation of about 1.2 KHz can be obtained with respect to a variation of 1% of the concentration of the toner. Thus, the concentration of the toner can be precisely detected.

A circuit requires integrator circuits or analog circuits such as filters or the like to mix frequencies using a mixer and detect using a filter. However, the above-described structure includes only logic circuits that may be installed inside a custom large scale integration (LSI) of a control circuit (not shown).

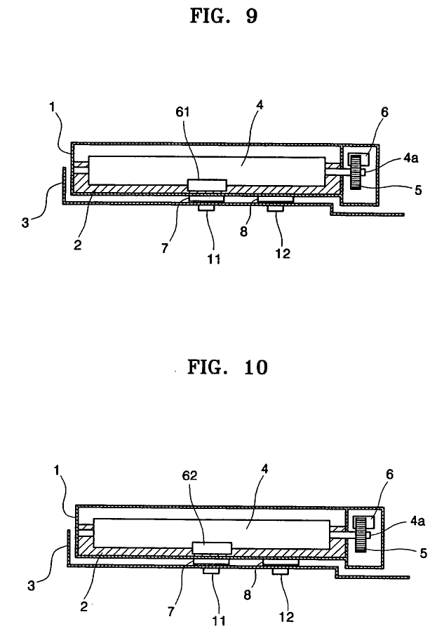

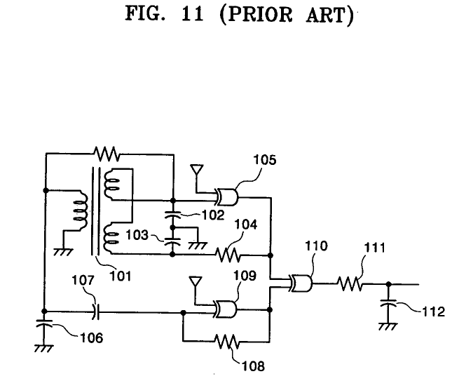

Moreover, in the embodiment described with reference to FIG. 1, the concentration sensor unit 8 is installed under the driving gears 5 and 6, but may be installed in any place that is not affected by the developer 2 or disposed in a position shown in FIG. 9.

As shown in FIG. 9, a scraper 61 may be installed on a girth of the mixer 4 agitating the developer 2 so as to face the concentration sensor unit 7. The scraper 61 rotates with a rotation of the mixer 4 causing the developer 2 accumulated on a lower portion of the housing 1 to be agitated with the rotation of the scraper 61. As a result, the developer 2 near the concentration sensor unit 7 is temporarily removed.

In a case where the scraper 61 is installed, the scraper 61 periodically scrapes the developer 2 and the concentration sensor unit 7 periodically depletes the permeability of the developer 2 to be equivalent to air. Thus, variations in a ratio or a difference between the frequencies of the concentration sensor units 7 and 8 may be observed at a fast time resolution with respect to a rotation cycle of the mixer 4, in order to obtain an absolute permeability of the developer 2, such as, the concentration of the toner.

As shown in FIG. 10, a standard sample 62 fixed to the mixer 4 may be installed so as to face the concentration sensor unit 7.

The standard sample 62 periodically causes standard permeability with respect to the concentration sensor unit 7. Thus, variations in the ratio or the difference between the frequencies of the concentration sensor units 7 and 8 may be observed at a fast time resolution with respect to the rotation cycle of the mixer 4, in order to obtain the absolute permeability of the developer 2, such as, the concentration of the toner.

As described above, according to the exemplary aspects of the present invention, in a detectable dynamic range, a detection range of a permeability reaches from air equivalent to several times a desired standard permeability. Thus, a highly precise toner concentration sensor can be realized without calibration. Also, a circuit may be constituted without using a highly-precise, large divider or subtracter and may be installed inside a control circuit.

Furthermore, a frequency deviation caused by temperatures of sensor units is canceled, and thus a complicated process such as compensation or calibration for the temperatures is not required.

In addition, circuits of the present invention are all logic circuits and may be installed inside a custom LSI of the control circuit. Thus, a low-priced toner concentration sensor not requiring a calibration can be realized and show a prominent effect in a color output apparatus having yellow, magenta, cyan, and black developing units.

In the exemplary embodiments of present invention, first and second concentration sensor units include oscillators. A periphery of a coil of the first concentrations sensor unit is filled with a developer. Since an inductance of the coil varies with permeability variations depending on the concentration of the toner, an oscillator frequency of the first concentration sensor unit is a frequency depending on the concentration of the toner. The second concentration sensor unit is disposed in a place that is not affected by the developer, and an oscillator frequency of the second concentration sensor is a reference frequency. Thus, a ratio or a difference between the oscillator frequencies of the first and second concentration sensor units is determined to detect the concentration of the toner.

In exemplary embodiments of the present invention, in a detectable dynamic range, a detection range of the permeability reaches from air equivalent to several times a desired standard permeability. Thus, a highly precise toner concentration sensor which does not require a calibration can be realized. Also, circuits, which are all logic circuits and may be installed inside a custom LSA of the control circuit, can be made compact without using a large scale divider or subtracter having a fixed density. In addition, a frequency deviation caused by temperatures of sensor units is canceled. Thus, compensation or calibration for the temperatures is not required.

While the invention has been shown and described with reference to certain exemplary embodiments thereof, it will be understood by those of ordinary skill in the art that various changes in form and details may be made therein without departing from the spirit and scope of the present invention as defined by the appended claims.

What is claimed is:

1. A toner concentration sensor used in an electrophotographic recording apparatus using a 2-component developing method, comprising:
a storage unit for storing a developer that comprises toner and carrier;
a first oscillator comprising a first resonance circuit comprising a coil and a condenser, the coil of the first resonance circuit is disposed in a place where an inductance of the coil varies with permeability of the developer stored in the storage;
a second oscillator comprising a second resonance circuit comprising a coil and a condenser, the coil of the second resonance circuit is disposed in a place where an inductance of the coil is substantially constant; and
a detector for detecting outputted oscillator frequencies of the first and second oscillators to determine the permeability of the developer,
wherein the concentration of the toner is based on from the permeability of the developer.

2. The sensor of claim 1, wherein the oscillator first and second oscillators are transmitted through induction by a detection coil installed near the coils on a portion of a main body structure of that supporting the storage unit.

3. The sensor of claim 1, wherein the coil of the second oscillator is disposed near a standard sample having a reference permeability.

4. The sensor of claim 1, further comprising a standard sample having a reference permeability, wherein the standard sample periodically performs an approach and separation around the coil of the first oscillator during rotation of the standard sample, a depletion of a portion of the developer on a lower housing that comprises the developer, or an installation of an element around the coil of the first oscillator that performs the depletion of a portion of the developer.

5. The sensor of claim 1, wherein the oscillator outputs of the first and second oscillators are detected and at least one of a ratio and a difference between the oscillator frequencies of the first and second oscillators is obtained so as to detect the permeability of the developer.

6. The sensor of claim 5, further comprising a logic circuit that comprises a counter counting the oscillator outputs of the first and second oscillators for obtaining the ratio or the difference between the oscillator frequencies of the first and second oscillators.

7. The sensor of claim 6, further comprising an operational circuit obtaining the ratio between the oscillator frequencies of the first and second oscillators, which comprises at least one of:
a divider dividing an output signal of the second oscillator into 1/n; and
a counter, synchronized by a signal output from the divider, counting the output signal of the first oscillator.

8. The sensor of claim 6, further comprising an operational circuit obtaining the ratio between the oscillator frequencies of the first and second oscillators, which comprises:
a selector alternately outputting output signals of the first and second oscillators; and
an up and down counter upcounting and downcounting the output signals of the first and second oscillators output through the selector.

9. A method of using a 2-component developing method in a toner concentration sensor used in an electrophotographic recording apparatus comprising:
storing a developer that comprises toner and carrier, wherein a permeability of the developer is based on a ratio of toner to carrier;
detecting a reference permeability;
detecting the permeability of the developer; and
determining a concentration of the toner by comparing the ratio of the reference permeability and the permeability of the developer.

10. The method of claim 9, wherein the permeability of the developer is detected based on an oscillator frequency from a first oscillator;

11. The method of claim 10, wherein the reference permeability is detected based on an oscillator frequency from a second oscillator.

12. The method of claim 11, wherein the first and second oscillator frequencies are transmitted through induction by a detection coil installed near coils on a portion of the main body structure of that supporting the storage unit.

13. The method of claim 9, wherein the reference permeability is provided in a standard sample that periodically performs an approach and separation around a coil of the first oscillator during rotation of the standard sample, a depletion of a portion of the developer on a lower housing that comprises the developer, or an installation of an element around the coil of the first oscillator that performs the depletion of a portion of the developer.

14. The method of claim 12, wherein detecting the permeability of the developer is based on at least one of a ratio and a difference between the oscillator frequencies of the first and second oscillators.

15. The method of claim 14, further comprising obtaining the ratio or difference between the oscillator frequencies of the first and second oscillators from a logic circuit that comprises a counter counting the oscillator outputs of the first and second oscillators.

16. The method of claim 15, further comprising obtaining the ratio between the oscillator frequencies of the first and second oscillators from an operational circuit, which comprises at least one method of:
dividing an output signal of the second oscillator into 1/n; and
counting the output signal of the first oscillator.

17. The method of claim 15, further comprising obtaining the ratio of the oscillator frequencies of the first and second oscillators from an operational circuit, which comprises the method of:
outputting output signals of the first and second oscillators; and
upcounting and downcounting the output signals of the first and second oscillators output through the selector.
